(19) United States
(12) Patent Application Publication
(10) Pub. No.: US 2026/0289006 A1
(43) Pub. Date: Sep. 24, 2026

(54) Data Warehouse Native Personally Identifiable Information (PII) Resolution

(71) Applicant: LiveRamp, Inc., San Francisco, CA (US)

(72) Inventors: Adam Zimmerman, Conway, AR (US); Shannon Duncan, Conway, AR (US); Breeona Dolega-Robinson, Jacksonville, FL (US); Connor Taffe, Little Rock, AR (US); Ragan Malott, Little Rock, AR (US); Zachary Peterson, Orlando, FL (US)

(21) Appl. No.: 19/477,902

(22) PCT Filed: Apr. 24, 2024
(86) PCT No.: PCT/US2024/025995

§ 371 Date: Oct. 23, 2025

Related U.S. Application Data
(60) Provisional application No. 63/462,144, filed on Apr. 26, 2023.

(51) Int. Cl. G06F 21/62; G06F 16/22

(52) U.S. Cl. CPC G06F 21/6245; G06F 16/22

(57) ABSTRACT

A system for performing entity resolution, specifically ranked personally identifiable information (PH) matching, within a data warehouse by utilizing user-defined functions in structured query language (SQL) can perform directly within a data warehouse's execution environment, thereby eliminating the need for data movement into an external system. The system utilizes an inverted index system operable with the distributed processing capabilities of data warehouses using an SQL and user-defined functions (UDF) implementation.

### CROSS-REFERENCE TO RELATED APPLICATIONS

This application claims the benefit of U.S. provisional patent application No. 63/462,144, filed on Apr. 26, 2023. Such application is incorporated herein by reference in its entirety.

### STATEMENT REGARDING FEDERALLY SPONSORED RESEARCH OR DEVELOPMENT

Not applicable.

### BACKGROUND

Personally identifiable information (PII) is a type of data that can be used to confirm the identity of someone, including names, addresses, phone number, etc. PII entity resolution processes data and merges matching records. Matching PII records from a source dataset to a target dataset is an important part of the marketing technology industry as it allows marketers to find and target addressable individuals with a high degree of accuracy. Many systems exist that perform PII entity resolution, which compares and matches sets of data stored across multiple channels.

An inverted index is a type of data structure that stores and organizes information to allow for efficient searches. Inverted Indexes are used frequently in information retrieval systems. Lucene and ElasticSearch are common systems that provide inverted index capabilities. These systems, however, cannot run natively within modern data warehouses such as BigQuery, Snowflake, and SingleStore.

References mentioned in this background section are not admitted to be prior art with respect to the present invention.

### SUMMARY

The present invention is directed to a system for performing entity resolution, specifically ranked PII matching, within a data warehouse's execution environment. While many systems exist that perform PII entity resolution, the present invention can perform ranked matching of PII records directly within a data warehouse or distributed database (e.g. BigQuery, Snowflake, SingleStore, Redshift), thereby eliminating the need for data movement into an external system. The invention utilizes an inverted index system operable with the distributed processing capabilities of data warehouses using a structured query language (SQL) and user-defined functions (UDF) implementation.

Performing PII resolution within a data warehouse provides the following advantages. First, sensitive PII data no longer needs to leave the warehouse compute environment. This allows users to take full advantage of their warehouse's data lineage and governance capabilities without taking an additional risk of using an external system to perform the resolution. Second, data warehouses often offer an easily scalable or “serverless” compute environment, allowing users to optimize their cloud compute utilization in an almost effortless manner.

These and other features, objects and advantages of the present invention will become better understood from a consideration of the following detailed description of the preferred embodiments and appended claims in conjunction with the drawings as described following:

### DRAWINGS

FIG. 1 is a flow diagram for an overview of a method of prospect scoring according to an embodiment of the present invention.

FIG. 2 is a flow diagram for a production system method according to an embodiment of the present invention.

FIG. 3 is a diagram illustrating the system architecture according to an embodiment of the present invention.

FIG. 4 is a flow diagram for a method of building a prospect token index according to an embodiment of the present invention.

FIG. 5 is a flow diagram for a production method of matching customer records according to an embodiment of the present invention.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

The objective of the invention is to match two tables containing rows of PII records to each other. In one embodiment, Table A will be referred to as the reference dataset and Table B will be referred to as the input dataset. A straightforward inner join of Table A and Table B will result in lower match rates than is expected because PII records are typically non-standardized and may contain errors. Instead of matching records in their entirety, the invention will generate many combinations of tokens from each record. Tokens are generated by splitting the PII data elements on whitespace. Then, the token combinations can be used as join keys within a data warehouse to generate higher match rates.

In an example of an embodiment, JOHN L SMITH II 123 MAIN ST is a record from Table A. This record contains seven tokens; four tokens for the name and three tokens for the street address. The following fifteen combinations of name tokens may be generated:
JOHN L SMITH II
JOHN L SMITH
II JOHN L
II JOHN SMITH
II L SMITH
JOHN L
JOHN SMITH
II JOHN
L SMITH
II L
II SMITH
JOHN
L
SMITH
II
   The following seven combinations of street address tokens may be generated:
123 MAIN ST
123 MAIN
123 ST
MAIN ST
123
MAIN
ST
   The order of the tokens is not important at this stage so the tokens are sorted lexicographically. Each combination of name and street address tokens will additionally be combined resulting in a total of 105 combinations.

In the same example, consider the following record from Table B:
JOHN SMITH 123 MAIN RD
   Using the same approach for token generation, the record contains a set of 21 tokens. When performing an inner join of the two sets of tokens, the following matches will be generated:
JOHN SMITH MAIN
SMITH 123 MAIN
JOHN SMITH 123 MAIN
JOHN SMITH 123
JOHN 123 MAIN
JOHN 123
JOHN MAIN
SMITH MAIN
SMITH 123

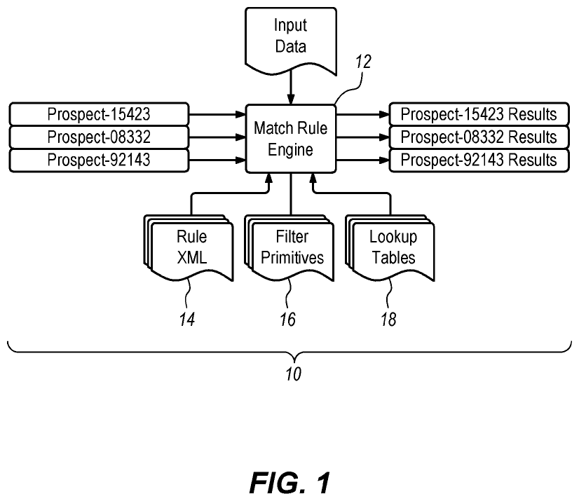

There is a potential or prospect match between the Table A record and the Table B record. As this is only considered a potential match, the scoring process 10, as shown in FIG. 1, will utilize a match rules engine 12 to compare the original Table A record to the Table B record to make the final decision as to whether this is a valid match or not. This process for generating prospect matches will be further optimized due to the extremely large number of records and token combinations that may exist in Table A and Table B.

The first optimization is ranking the quality of prospect matches based on their readiness for use. This can be accomplished by assigning a score to each token that considers the number of tokens and the frequency of the tokens that make up the prospect token. The system 10 does not need to return all matches of token combinations between two records. Rather, the system 10 only needs to consider the highest scoring token combination match for a given prospect. Further, the system 10 will only consider the top 15 highest scoring prospects in a particular embodiment. The top 15 prospect matches must be additionally filtered before determining if a suitable match has been found. Match rule engine 12 performs this matching capability, illustrated in FIG. 1.

As shown in FIG. 1, match rule engine 12 is positioned natively within a data warehouse, so that no data is moved outside of the warehouse's execution and storage environment. The system 10 will generate match engine code that can be executed within a data warehouse's user-defined functions (UDF) execution environment, in order to implement match rule engine 12.

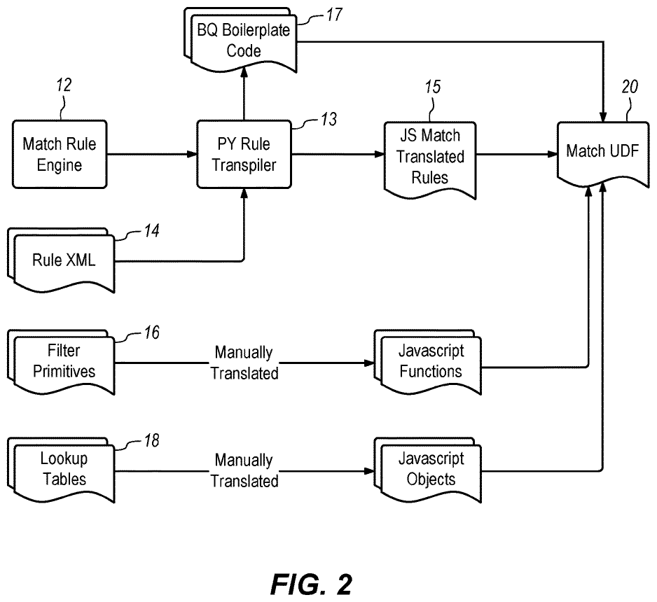

FIG. 2 illustrates the flow of source code, configuration, and data required to transpile match rules into a Javascript UDF executed in BigQuery. Match rule engine 12 is a programmatic framework for defining and executing match rules. The match rules are designed to return a numeric score that represents the likelihood that two records are a match. The match rules are defined in an XML format 14 and are executed by match rule engine 12. The match rule engine is designed to be extensible and can be customized to meet the specific needs of the user or adjust to changes in the data.

Match rules are composable and can be composed in any combination. As such, the engine is a general purpose computing framework. The method by which the engine combines match rules is translated into python code at rule transpiler 13, which in turn can automatically generate Javascript code as match translated rules 15, which can execute the logic defined in Rule XML 14.

BigQuery boilerplate code 17 is the top level interface between a BigQuery UDF definition and the Javascript code that runs within the UDF. It is integrated into the final Match UDF definition 20 as part of the interface specification.

Match rule engine 12 contains the definition of how to chain primitives when calculating a numeric likelihood score that two records match. The Rule XML configuration 14 is read in by PY Rule Transpiler 13 so that Javascript code (logical flow i.e. if-else statements, chaining of primitives, and interface definitions) can be generated as match translated rules 15.

Filter Primitives 16 is a library of code primitives whose use can be configured in XML when comparing a prospect to an input record. The types of functionality include but are not limited to: Add, Multiple, Divide, Edit Distance, IsNickName, etc. Java implementation of primitive functions 16 is used by the Rule XML 14. The primitive functions all share an identical interface so that they can be composed in any combination.

Lookup tables 18 are manually curated datasets used as reference data when some primitives are comparing two records, including but not limited to nickname table, gender lookup table, and street suffix table. Match rule engine 12 will input rule XML 14, filter primitives 16, and lookup tables 18, and produce a match UDF 20 and SQL interface compatible with the target data warehouse. For example, a table in lookup tables 18 may contain a list of first names along with a corresponding set of nicknames. Other examples include a list of first names along with a highly probable gender for the individual with that name, or a list of postal address street suffixes along with common abbreviations for that street suffix.

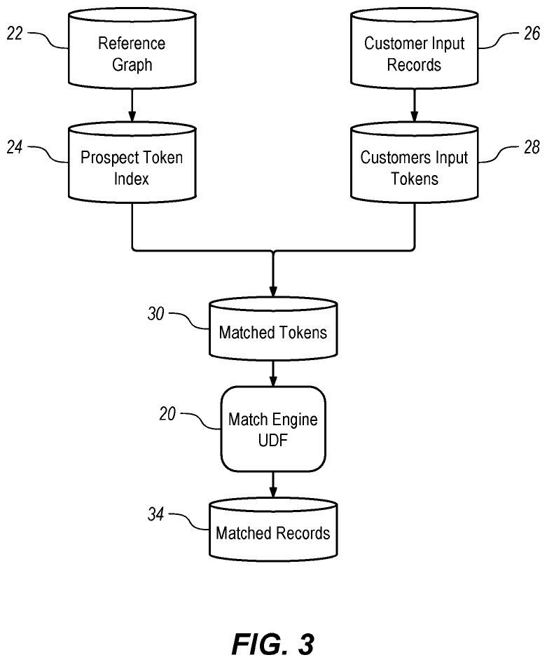

As shown in FIG. 3, the system architecture comprises the following tables and steps: reference graph 22; prospect token index 24; customer input records/table 26; customer input tokens 28; matched tokens 30; match engine UDF 20; and matched records 34. The system architecture supports the ability to push down aggregation and filtering of query results to leaf processing nodes before subsequent aggregation and filtering on aggregator nodes takes place. This is a key feature to scaling the invention because each leaf processing node will be able to determine the highest scoring token combination for a given prospect and filter all records, except the top 15 highest scoring prospects local to the leaf node before sending results to an aggregator node. Generalizing this information retrieval approach to any short length document store (ten or fewer terms per document) results in a massively parallel inverted index of short length documents implemented natively within a data warehouse.

Reference graph 22 contains the short-length document store which in this embodiment contains PII entity records of names, postal address, email addresses, and phone numbers. Each entity record is stored as a set of PII tokens. Each record in this table is transformed using SQL into its set of unique token combinations. In an example, reference graph 22 may contain approximately ten billion name and postal address records.

Prospect token index 24 is a table, where each row contains a unique combination of tokens for one of the PII short-length document records. This table will become the primary index for searching for prospect PII matches. In an example, prospect token index 24 may contain approximately 600 billion token combinations.

Customer input records 26 contains the set of PII records that a typical user would use as their knowledgebase of consumers. Each PII record is transformed using SQL into its set of unique token combinations. The token combinations are generated in the same manner as the reference graph 22. In an example, customer input records 26 may contain up to fifty million name and postal address records.

Customer input tokens 28 is a table in which each row contains a unique combination of tokens for one of the PII customer records. This table will be joined to prospect token index 24 to search for prospect PII matches. In an example, customer input tokens 28 may contain up to three billion token combinations.

Matched tokens 30 is a table that is a result set from the inner join of prospect token index 24 and customer input tokens 28. This result set contains, for each customer record, up to 15 prospect matches. Prospect matches are PII records that match all or some of the PII tokens. The prospect matches are ordered by a numeric match score that represents an approximation of how closely the records match. In an example, matched tokens 30 may contain up to 750 million prospect matches

Match engine UDF 20, as previously described, compares each of the 15 prospects to the original customer record and returns a score and final decision of whether the record meets all of the match criteria defined in Rules XML 14. Thus match engine UDF 20 filters the prospect matches using match rule engine 12.

The table of matched records 34 contains the original customer PII records that have been matched to the reference graph 22. The information in this table is restricted to an identifier that points to a record and metadata about the quality and strength of the match that was performed.

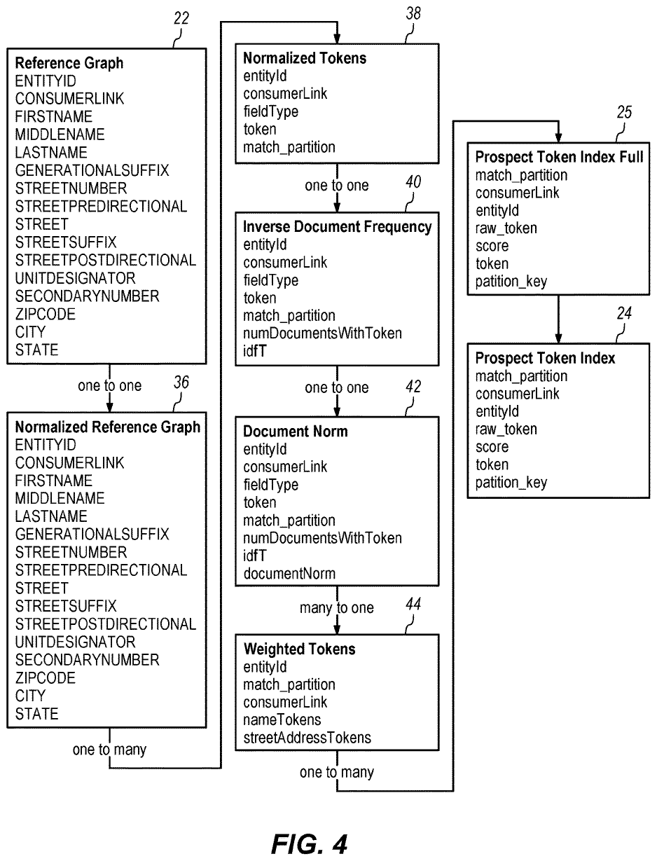

As illustrated in FIG. 4, the method of building a prospect token index includes the following tables and steps: reference graph 22; normalized reference graph 36; normalized tokens 38; inverse document frequency 40; document norm 42; and weighted tokens 44, resulting in prospect token index full 25 and (final) prospect token index 24. Reference graph 22 contains all third party matchable entities. In one embodiment, using a large consumer database, this table may contain tens of billions of rows. Reference graph 22 includes the following data fields:
ENTITYID
CONSUMERLINK—(a unique identifier for a person)
FIRSTNAME
MIDDLENAME
LASTNAME
GENERATIONALSUFFIX
STREETNUMBER
STREETPREDIRECTIONAL
STREET
STREETSUFFIX
STREETPOSTDIRECTIONAL
UNITDESIGNATOR
SECONDARYNUMBER
ZIPCODE
CITY
STATE
   Then, the table will pass through a normalization UDF, which performs basic data transformations such as standardizing a postal ZIP code to be five digits and removing extraneous whitespace in other PII fields. The result, normalized reference graph 36, includes the same data fields as reference graph 22.

Tokens are obtained by splitting each PII field by whitespace. The normalized tokens 38 include the following data fields:
entityId
consumerLink
fieldType
token
match_partition
   The field “fieldType” indicates a name or street address and is used to calculate a normalized weight representing the value of matching to the given token. The field “match_partition” refers to the partition key used for matching purposes, which in one embodiment is the five digit zipCode. This is distinct from the more generic partition_key which is used to partition data storage within the data warehouse. Two nominal values are calculated for each token by grouping the rows on (fieldType, token, match_partition). The entities from normalized reference graph 36 are bursted into one row per each PII token. Tokens are obtained by splitting each PII field by whitespace. The fieldType can be either name or streetAddress and will subsequently be used to calculate a normalized weight representing the value of matching to the given token.

The result of the above-described process, inverse document frequency 40, then includes the following data fields:
entityId
consumerLink
fieldType
token
match_partition
numDocumentsWithToken
idfT
   Two nominal values are calculated for each token by grouping the rows on (fieldType, token, match_partition). The field “numDocumentsWithToken” is a simple frequency metric. The field “idfT” refers to the inverse document frequency of the token calculated as
log(totaldocuments/(numDocumentsWithToken+1)).

Document norm 42 includes the following data fields:
entityId
consumerLink
fieldType
token
match_partition
numDocumentsWithToken
idfT
documentNorm
   The field “documentNorm” is a final calculated value, which assigns a weight to the importance of matching to the given field (fieldType, token, match_partition). The weight is inversely proportional to the frequency of the token, such that more common values carry lesser weight than rare tokens. Then, tokens are aggregated back together with their respective entities by grouping on entityId.
   Weighted tokens 44 includes the following data fields:
entityId
match_partition
consumerLink
name Tokens
streetAddressTokens
   Name Tokens are generated when PII name information is split on whitespace. For example, the string “JOHN L SMITH” would become the set of tokens “JOHN”, “L”, and “SMITH”. The streetAddress Tokens are generated similarly, when street address information is split on whitespace to generate a set of streetAddress tokens.

For each entity and its set of name Tokens and streetAddress tokens, all n choose k combinations of tokens are generated and scored. This allows for the implementation of a distributed inverted index directly in a data warehouse, and is uniquely feasible in this domain because of the relatively small number of tokens that an entity representation may contain (usually fewer than ten tokens). The scoring function uses the documentNorm of each token to calculate a score that represents how likely the entity is to match. This score allows for ranking of all potential matches and efficiently prunes entities that are lower ranked.

Prospect token index full 25 includes the following data fields:
match_partition
consumerLink
entityId
score
token
partition_key
   A partition key is computed so that the amount of data queried when performing a match can be drastically decreased, which leads to increased performance and decreased cost to compute results. In this embodiment, the partition_key is calculated from the postal address zipCode. In some cases it may be the ZIP code itself, and in other cases a remainder division operator (modulo) may be used to reduce the total number of partitions to a value compatible with the data warehouse.

Finally, within a Match Partition the identical token combinations, coming from different prospects, beyond rank 15 ordered by score are discarded. For example, the 123 Main token combination could be present in hundreds of prospects, but only the top 15 of that token combination need to be considered, as the others will never be above the cutoff. This is an optimization to prune tokens which will never match within a match partition. A different cut-off number may be used in alternative embodiments of the invention. The number of common token combinations considered when finding prospects is significantly reduced in this way, which leads to a decrease in the amount of data scanned, shuffled and aggregated. This results in faster and more efficient matching queries on the data warehouse. The result is prospect token index 24, which has the same types of values as prospect token index full 25.

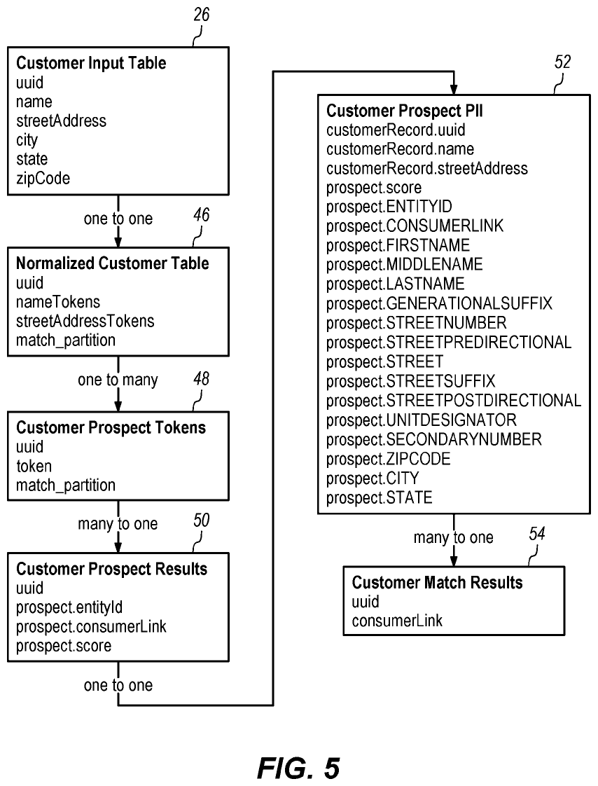

As shown in FIG. 5, the process for prospect and match comprises the following tables and steps: customer input records/table 26; normalized customer table 46; customer prospect tokens 48; customer prospect results 50; customer prospect PII 52; and customer match results 54. The customer input table 26 contains the set of customer records to be matched against reference graph 22. The primary objective of the matching process is to determine the best consumerLink for each row in this table. Customer input table 26 includes the following data fields:
uuid
name
streetAddress
city
state
zipCode
   Uuid is a universal unique identifier commonly used in computer systems, which may be implemented as a 128-bit value. The PII data from the previous table is normalized and split into tokens by splitting each field by whitespace. Normalized customer table 46 includes the following data fields:
uuid
name Tokens
streetAddressTokens
match_partition

For each record and its set of name Tokens and streetAddress tokens, all n choose k combinations of tokens are generated. These tokens are used as an inner join key to the prospect token index 24. Customer prospect tokens 48 includes the following data fields:
uuid
token
match_partition
   Customer prospect token table 44 is inner joined with prospect token index 24. The inner join are grouped by (uuid, entityId) to determine the highest match score for an entityId. Then, the results are grouped by uuid to determine the top fifteen scoring entityIds for the uuid, in an embodiment. This method allows most distributed data warehouses to perform local aggregation and filtering on leaf nodes before shuffling data on aggregator nodes. The result is a very efficient pruning of invalid matches that can scale horizontally to match thousands of nodes. Customer prospect results 50 include the following data fields:
uuid
prospect.entityId
prospect.consumerLink
prospect.score

In customer prospect PII 52, once the top fifteen prospects are identified for each input record, in an embodiment, each uuid is joined to its original PII in customer input records 26 and each entityId to its original PII from match rule engine 12. Customer prospect PII 52 includes the following data fields:
customerRecord.uuid
customerRecord.name
customerRecord.streetAddress
prospect.score
prospect.ENTITYID
prospect.CONSUMERLINK
prospect.FIRSTNAME
prospect.MIDDLENAME
prospect.LASTNAME
prospect.GENERATIONALSUFFIX
prospect.STREETNUMBER
prospect.STREETPREDIRECTIONAL
prospect.STREET
prospect.STREETSUFFIX
prospect.STREETPOSTDIRECTIONAL
prospect.UNITDESIGNATOR
prospect.SECONDARYNUMBER
prospect.ZIPCODE
prospect.CITY
prospect.STATE

Customer match results 54 is the result of the input record and the top fifteen prospects being passed into a UDF containing match rule engine 12. The UDF is created automatically generating code that can be executed within a data warehouse's UDF execution environment, including but not limited to JavaScript, Python, and web assembly. The auto-generated code is a port of the match rule engine 12 logic.

In an embodiment of the invention, the logical UDF components of the invention comprise each of the following:
1. UDF to normalize PII data;
2. UDF to calculate total documents per partition;
3. UDF to calculate inverse document frequency of token;
4. UDF to calculate total tokens per field;
5. UDF to calculate normalized weight for each token within a document;
6. UDF to generate scored prospect token permutations;
7. UDF to prepare customer data for matching on prospect tokens;
8. UDF to find prospect match AbiliTec entities for the input entity tokens; and
9. UDF to execute matching logic between an input record and a prospect record.

In an embodiment of the invention, the minimum requirements to operate in a production environment include: the warehouse must have the ability to store at least 100 TB of data; the warehouse must have the ability to store at least 1 trillion rows of data; the warehouse must have the ability to store at least 100 columns of data; the warehouse must have the ability to execute non-SQL UDF code such as, but not limited to; JavaScript, java, python, WASM; and the warehouse must have the ability to perform standard SQL joins and combinations of SQL joins; LEFT, RIGHT, OUTER, INNER.

The methods described herein may in various embodiments be implemented by any combination of hardware and software. For example, in one embodiment, the methods may be implemented by a computer system or a collection of computer systems, each of which includes one or more hardware processors executing program instructions stored on a computer-readable physical storage medium coupled to the hardware processors. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

Computer systems may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and subcombinations possible of the group are intended to be individually included. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for matching personally identifiable information records within a data warehouse execution environment, comprising the steps of:
receiving a source dataset in the data warehouse execution environment, wherein the source dataset comprises personally identifiable information (PII);
generating an index of prospect token combinations from the source dataset;
generating prospect token matches from the index of token combinations using a match engine located natively within the data warehouse execution environment;
filtering the token matches to produce a set of filtered token matches; and
producing matched customer records from the filtered token matches.

2. The method according to claim 1, wherein the step of generating an index of prospect token combinations further comprises the steps of:
merging third party matchable entities;
passing the third party matchable entities through a set of normalization user-defined functions where data transformations are performed;
breaking down entities into one row per each token;
calculating inverse document frequency of a token;
calculating total tokens per field;
calculating normalized weight for each token within a document; and
generating scored token permutations.

3. The method according to claim 2, further comprising the step of preparing customer data for matching tokens.

4. The method according to claim 3, further comprising the step of filtering prospect match entities for input entity tokens.

5. The method according to claim 4, further comprising the step of executing matching between an input record and a prospect record within the data warehouse execution environment.

6. The method according to claim 5, further comprising the step of applying a cut-off value to the scored token permutations, and discarding those scored token permutations below the cut-off value.

7. A cloud-computing environment comprising one or more computer processors and a memory space having instructions stored therein, the instructions, when executed by the one or more computer processors, causing the one or more computer processors to:
receive a source dataset comprising personally identifiable information (PII);
generate an index of prospect token combinations from the source dataset;
generate prospect token matches from the index of token combinations;
filter the token matches to produce a set of filtered token matches; and
produce matched customer records from the filtered token matches.

8. The cloud computing environment of claim 7, wherein the instructions, when executed by the one or more computer processors to generate an index of prospect token combinations, further comprise instructions that, when executed by the one or more computer processors, cause the processors to:
merge third party matchable entities;
pass the third party matchable entities through a set of normalization user-defined functions where data transformations are performed;
break down entities into one row per each token;
calculate inverse document frequency of a token;
calculate total tokens per field;
calculate normalized weight for each token within a document; and
generate scored token permutations.

9. The cloud computing environment of claim 8, wherein the instructions, when executed by the one or more computer processors, further cause the one or more computer processors to prepare customer data for matching tokens.

10. The cloud computing environment of claim 9, wherein the instructions, when executed by the one or more computer processors, further cause the one or more computer processors to filter prospect match entities for input entity tokens.

11. The cloud computing environment of claim 10, wherein the instructions, when executed by the one or more computer processors, further cause the one or more computer processors to execute matching between an input record and a prospect record.

12. The cloud computing environment of claim 11, wherein the instructions, when executed by the one or more processors, further cause the one or more computer processors to apply a cut-off value to the scored token permutations, and discard those scored token permutations below the cut-off value.

13. A cloud computing environment comprising:
a total documents user defined function (UDF) configured to calculate total documents per partition within a set of data comprising personally identifiable information (PII);
an inverse document frequency UDF configured to calculate inverse document frequency of tokens within the documents;
a total tokens UDF configured to calculate total tokens per field within the documents;
a normalization weight UDF configured to calculate normalized weight for each token within each of the documents;
a scored prospect token permutations UDF configured to generate scored prospect token permutations for the documents;
a customer data preparation UDF configured to prepare customer data for matching on prospect tokens within the documents;
a prospect match entity find UDF configured to find prospect match entities for the prospect tokens; and
a matching logic UDF configured to execute matching logic between an input record from the set of data comprising PII and a prospect record to produce a set of token matches.

14. The cloud-computing environment of claim 13, further comprising a normalization UDF configured to normalize the set of data comprising PII.

15. The cloud computing environment of claim 14, further comprising an index UDF configured to generate an index of prospect token combinations from the set of data comprising PII.

16. The cloud computing environment of claim 15, wherein the index UDF is further configured to merge third party matchable entities.

17. The cloud computing environment of claim 16, wherein the index UDF is further configured to generate scored token permutations for the set of data comprising PII.

18. The cloud computing environment of claim 17, wherein the matching logic UDF is further configured to filter the set of token matches to produce a set of filtered token matches.

19. The cloud computing environment of claim 18, wherein the matching logic UDF is further configured to produce a set of matched customer records from the set of filtered token matches.
